(19) United States
(12) Patent Application Publication
(10) Pub. No.: US 2024/0317080 A1
(43) Pub. Date: Sep. 26, 2024

(54) WIRELESS POWER TRANSFER SYSTEM

(71) Applicant: Mitsubishi Electric Corporation, Tokyo (JP)

(72) Inventors: Mariko NAKAGAWA, Tokyo (JP); Tomokazu SAKASHITA, Tokyo (JP); Hidehito YOSHIDA, Tokyo (JP)

(73) Assignee: Mitsubishi Electric Corporation, Tokyo (JP)

(21) Appl. No.: 18/579,502

(22) PCT Filed: Jul. 21, 2021
(86) PCT No.: PCT/JP2021/027354

§ 371 Date: Jan. 16, 2024

(51) Int. Cl. B60L 53/10; B60L 53/62; H02J 50/40; H02J 50/90

(52) U.S. Cl. CPC B60L 53/10; B60L 53/62; H02J 50/40; H02J 50/90

(57) ABSTRACT

A wireless power transfer system includes a plurality of power transmitters and a power receiver. The plurality of power transmitters are arranged in a hoistway in line with a moving direction of a car. The power receiver is installed on the car. A power transmitting device supplies electric power to the plurality of power transmitters and the plurality of power transmitters transmits electric power to the power receiver without contact. The electric power received by a power receiving device from the power receiver is supplied to a load device. A dimension of the power receiver in the moving direction of the car is larger than a dimension of each of the plurality of power transmitters in the moving direction of the car.

### TECHNICAL FIELD

The present disclosure relates to a wireless power transfer system to be used for an elevator.

### BACKGROUND TECHNOLOGY

In a general elevator, electric power is supplied via a power transmitting cable to a load installed in a car. However, in the case of high-speed or high-lift elevators, it is difficult to install the power transmitting cable due to its increased weight. Therefore, introduction of wireless power transmission technology that does not use the power transmitting cable is being considered. For example, a wireless electric power transmission system described in Patent Document 1 includes a plurality of power transmitting coil units and a plurality of power receiving coil units corresponding to the plurality of power transmitting coil units. The plurality of power receiving coil units receive electric power in a non-contact manner from the plurality of power transmitting coil units by being coupled with a magnetic field generated by the plurality of power transmitting coil units.

### PRIOR ART REFERENCES

### Patent Documents

[Patent Document 1] Japanese Unexamined Patent Application Publication No. 2017-169277

### SUMMARY OF THE INVENTION

### Problems to be Solved by the Invention

However, in the wireless electric power transmission system disclosed in Patent Document 1, power transmission without contact is possible only when the plurality of power receiving coil units are at specific positions with respect to the plurality of power transmitting coil units. Therefore, when the wireless electric power transmission system of Patent Document 1 is applied to an elevator, the stoppage time of a car must be longer to allow for the time required for power transmission. As a result, there has been a problem that the operating efficiency of the elevator is decreased.

The present disclosure is made to solve the above problems and aims to provide a wireless power transfer system capable of suppressing the decrease in operating efficiency of an elevator.

### Means for Solving the Problems

A wireless power transfer system according to the present disclosure to supply electric power without contact to a car moving in a hoistway of an elevator includes: a plurality of power transmitters disposed in the hoistway so as to be aligned in a moving direction of the car; a power transmitting device to supply electric power to the plurality of power transmitters; a power receiver to receive electric power from the plurality of power transmitters without contact, the power receiver being installed on the car; a power receiving device to receive electric power from the power receiver; a load device to which the electric power received by the power receiving device is supplied; and a controller to control the power transmitting device and the power receiving device, wherein a dimension of the power receiver in the moving direction of the car is larger than a dimension of each of the plurality of power transmitters in the moving direction of the car.

### Effects of the Invention

The wireless power transfer system according to the present disclosure is capable of suppressing the decrease in operating efficiency of an elevator.

### BRIEF DESCRIPTION OF THE DRAWINGS

FIG. 1 shows a configuration of an elevator system including a wireless power transfer system according to Embodiment 1.

FIG. 2 shows a schematic cross-sectional diagram of example configurations of a power transmitting coil and a power receiving coil.

FIG. 3 is a block diagram showing a configuration of the wireless power transfer system.

FIG. 4 is a schematic side view showing the change in a positional relationship between the power transmitting coils and the power receiving coil.

FIG. 5 is a flowchart showing an example of controlling a load device on the basis of transmittable electric power.

FIG. 6 is a schematic side view showing the change in position of a power receiving coil with respect to one specific power transmitting coil.

FIG. 7 is a block diagram showing a configuration of a wireless power transfer system according to Embodiment 2.

FIG. 8 is a flowchart showing an example of controlling a load device on the basis of the charge amount of a power storage device.

FIG. 9 is a schematic perspective view showing the power receiving coil used by a wireless power transfer system according to Embodiment 3.

FIG. 10 is a schematic cross-sectional diagram of the power receiving coil and the power transmitting coil facing the power receiving coil of FIG. 9.

FIG. 11 is a schematic cross-sectional view showing another modification of the power transmitting coil and the power receiving coil.

### EMBODIMENTS FOR CARRYING OUT THE INVENTION

Hereinafter, the wireless power transfer system according to embodiments of the present disclosure will be described with reference to the drawings. The wireless power transfer system according to the embodiments herein can be applied to elevator systems.

### Embodiment 1

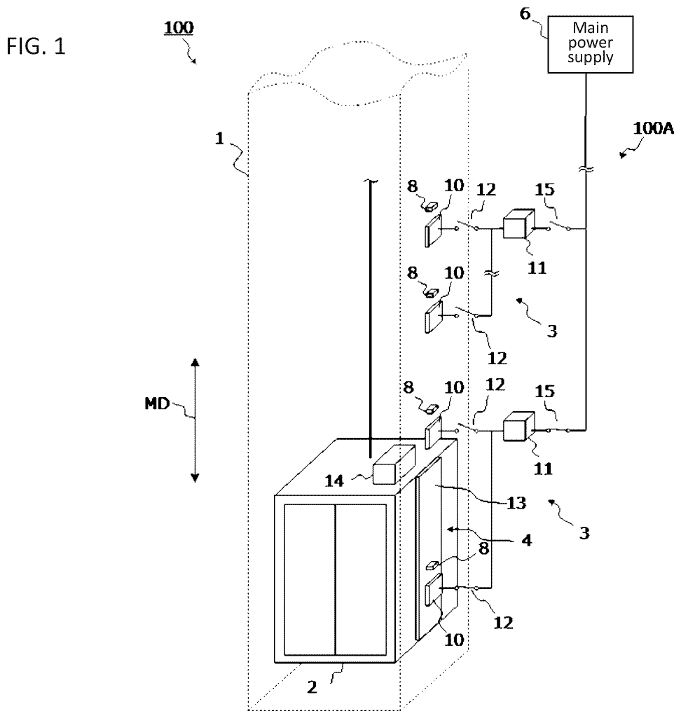

FIG. 1 shows a configuration of an elevator system including a wireless power transfer system according to Embodiment 1. As shown in FIG. 1, an elevator system 100 in Embodiment 1 includes a hoistway 1, a car 2, and a wireless power transfer system 100A. The hoistway 1 is provided to extend in a vertical direction. The car 2 is installed to allow vertical movement within the hoistway 1. Hereinafter, the moving direction (vertical direction) of the car 2 is referred to as a moving direction of the car MD. The moving direction of the car MD is not limited to the vertical direction, but may be any direction that makes an angle with respect to the vertical direction. In this example, the hoistway 1 and the car 2 constitute an elevator.

The wireless power transfer system 100A includes a plurality of power transmitting units 3, a power receiving unit 4, a main power supply 6, and a plurality of detection circuits 8. The plurality of power transmitting units 3, the main power supply 6, and the plurality of detection circuits 8 are disposed on the side of the hoistway 1. The power receiving unit 4 is disposed on the side of the car 2. The wireless power transfer system 100A supplies the car 2 moving in the hoistway 1 of the elevator with electric power without contact.

The main power supply 6 is connected to the plurality of power transmitting units 3 through a plurality of power transmitting unit switches 15. In this example, the case where the main power supply 6 is a DC power source will be described. However, the main power supply 6 may also be an AC power source. When the main power supply 6 is an AC power source, an AC/DC converter is provided between the main power supply 6 and a plurality of power transmitting devices 11.

Each power transmitting unit 3 includes a plurality of power transmitting coils 10, a power transmitting device 11 for supplying electric power to the plurality of power transmitting coils 10, and a plurality of power transmitting coil switches 12 each disposed between the power transmitting device 11 and each power transmitting coil 10. The power transmitting device 11 includes a DC/AC converter for converting DC power from the main power supply 6 to AC power and supplying the AC power to the power transmitting coils 10. The plurality of power transmitting coils 10 are disposed on the wall of the hoistway 1 in such a manner that they are aligned in the moving direction of the car MD. The power transmitting coils 10 correspond to the power transmitters in the claims. The number of the power transmitting coils 10 to be provided in each power transmitting unit 3 does not need to be constant, but may be adjusted depending on the model or the height of the hoistway 1 or the location of the installation.

The plurality of detection circuits 8 are disposed in correspondence to the respective power transmitting coils 10. Each detection circuit 8 detects a current flowing through the corresponding power transmitting coil 10.

The power receiving unit 4 includes a power receiving coil 13 on a side of the car 2 facing the power transmitting coils 10, and a power receiving device 14 for receiving electric power from the power receiving coil 13. The power receiving coil 13 is provided to extend in the moving direction of the car MD to have an elongated shape. The power receiving coil 13 corresponds to the power receiver in the claims. The dimension of the power receiving coil 13 in the moving direction of the car MD (hereinafter referred to as a length of the power receiving coil 13) is set larger than the dimension of each power transmitting coil 10 in the moving direction of the car MD (hereinafter referred to as a length of the power transmitting coil 10). In the example shown in FIG. 1, the power transmitting coils 10 and the power receiving coil 13 each have a rectangular shape. However, the shape of the power transmitting coils 10 and the power receiving coil 13 is not limited thereto and may be circular, hexagonal, etc.

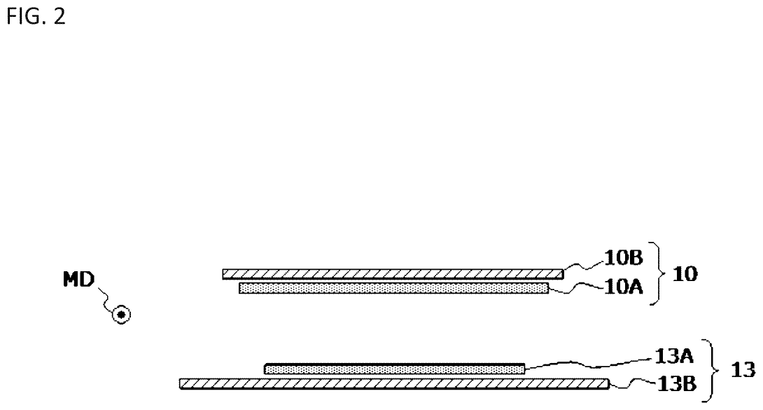

FIG. 2 shows a schematic cross-sectional diagram of example configurations of the power transmitting coils 10 and the power receiving coil 13. The cross-sectional surfaces in FIG. 2 are perpendicular to the moving direction of the car MD. In the example shown in FIG. 2, the power transmitting coil 10 has a two-layer structure consisting of a winding 10A and a magnetic material 10B. Similarly, the power receiving coil 13 has a two-layer structure consisting of a winding 13A and a magnetic material 13B. Each power transmitting coil 10 and the power receiving coil 13 are arranged in such a manner that the winding 10A and the winding 13A face each other. The magnetic materials 10B and 13B are not essential, and either or both of the magnetic materials 10B and 13B may be dispensed with if magnetic field coupling between the power transmitting coil 10 and the power receiving coil 13 occurs.

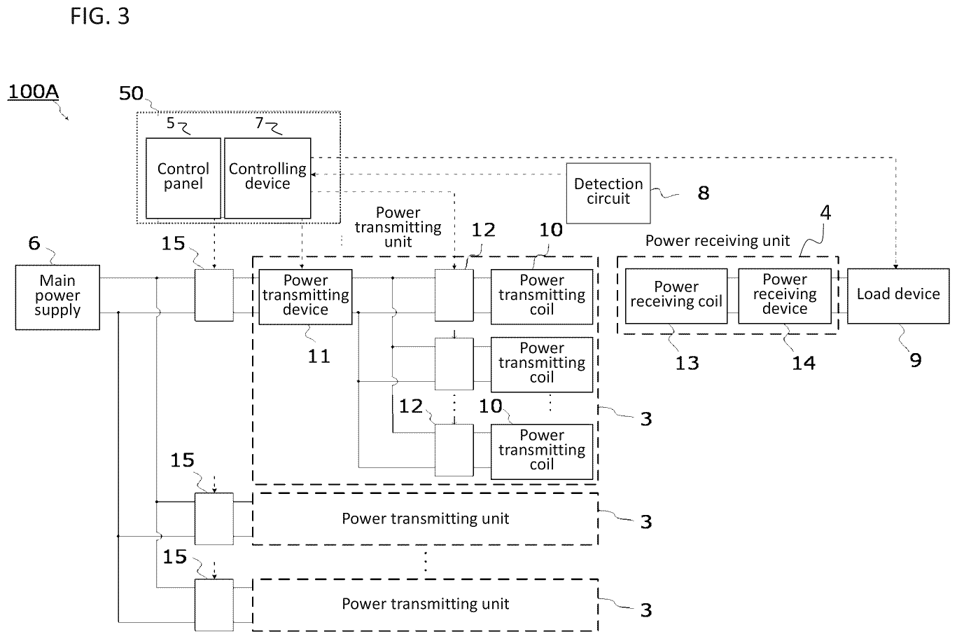

FIG. 3 is a block diagram showing a configuration of the wireless power transfer system 100A. As shown in FIG. 3, the wireless power transfer system 100A further includes a controller 50 and a load device 9. The controller 50 includes a control panel 5 and a controlling device 7. The control panel 5 and the controlling device 7 each include, for example, a processing unit (processor) and a storage unit (memory).

The control panel 5 controls the overall operation of the elevator system 100. The control panel 5 is installed, for example, in a machine room provided on the roof of a building. Instead, the control panel 5 may be installed on the wall of the hoistway 1. There may be more than one control panel 5.

Each power transmitting unit switch 15 is controlled by the control panel 5 to be either in a connected state in which the main power supply 6 and the power transmitting unit 3 are electrically connected, or in a disconnected state in which the main power supply 6 and the power transmitting unit 3 are electrically disconnected.

The controlling device 7 can communicate with the control panel 5 by wireless or wired means, and controls a power transmitting device 11 and power transmitting coil switches 12 of each power transmitting unit 3, as well as the load device 9. Signals transmitted between the controlling device 7 and the control panel 5 may be either analogue or digital signals.

Each power transmitting coil switch 12 of each power transmitting unit 3 is switched by the controlling device 7 between a connected state in which the corresponding power transmitting coil 10 and the power transmitting device 11 are electrically connected and a disconnected state in which the corresponding power transmitting coil 10 and the power transmitting device 11 are electrically disconnected.

The power transmitting unit 3 electrically connected to the main power supply 6 by the power transmitting unit switch 15 is supplied with electric power by the main power supply 6. In the same power transmitting unit 3, the power transmitting coils 10 electrically connected to the power transmitting device 11 by the respective power transmitting coil switches 12 are supplied with electric power by the power transmitting device 11. When each of the power transmitting coils 10 supplied with electric power and the power receiving coil 13 are facing each other, electric power is transmitted from the power transmitting coil 10 to the power receiving coil 13 without contact.

In the present embodiment, an electromagnetic induction method is used as the contactless power transmission method for transmitting electric power from the power transmitting coils 10 to the power receiving coil 13 without contact. However, instead of the electromagnetic induction method, other methods such as an electric field resonance method can be used for contactless power transmission. When the electric field resonance method is used as the contactless power transmission method, power transmitting electrodes are used as the power transmitters instead of the power transmitting coils 10, and a power receiving electrode is used as the power receiver instead of the power receiving coil 13. In this case, the dimension of the power receiving electrode in the moving direction of the car MD is set larger than the dimension of the power transmitting electrodes in the moving direction of the car MD.

The electric power transmitted to the power receiving coil 13 is received by the power receiving device 14 and supplied to the load device 9 installed in the car 2. The load device 9 includes, for example, a lighting system and an air conditioning system in the car 2.

Each detection circuit 8 detects a current flowing through the corresponding power transmitting coil 10 and provides current information representing the magnitude of the detected current to the controlling device 7.

The communication between the components located in the car 2 and the components located outside the car 2, for example in the hoistway 1, should preferably be wireless. For example, when the detection circuits 8 are located in the hoistway 1, the detection circuits 8 should preferably send the current information to the controlling device 7 by wireless means. In addition, the controlling device 7 should preferably control each power transmitting unit 3 and the load device 9 by wireless means.

In this example, one controlling device 7 is provided for the plurality of power transmitting units 3. However, a plurality of the controllers 7 each corresponding to one of the plurality of power transmitting units 3 may be provided. In this example, the controlling device 7 is provided to control the power transmitting units 3 separately from the control panel 5 for controlling the entire elevator system 100. However, the control panel 5 may have some or all of the functions of the controlling device 7, or conversely, each controlling device 7 may have some or all of the functions of the control panel 5. Alternatively, the control panel 5 and the controlling device 7 may be provided integrally as a single controller 50.

The locations of the control panel 5, the controlling device 7, the power transmitting units 3, and the power receiving unit 4 are not specifically limited, but may be changed as appropriate within a range that allows the similar functions and effects.

As described above, in the present embodiment, the length of the power receiving coil 13 is set larger than the length of the power transmitting coils 10. This causes the power receiving coil 13 to face each power transmitting coil 10 for a certain period of time, even while the car 2 is moving. Thus, it is possible to transmit electric power from the power transmitting units 3 to the power receiving unit 4 not only when the car 2 is at a specific position, but also while the car 2 is moving. As a result, the decrease in elevator operating efficiency can be controlled.

Since the length of the power receiving coil 13, rather than the length of the power transmitting coils 10, is configured to be large, it is possible to transmit electric power from the power transmitting units 3 to the power receiving unit 4 of the moving car 2 without increasing the size of the power transmitting coils 10. It may be possible to increase the length of each power transmitting coil 10 to transmit electric power from the power transmitting units 3 to the power receiving unit 4 of the moving car 2. However, in this case, a plurality of larger power transmitting coils 10 must be installed in the height direction of the hoistway 1, which increases the time and cost of maintenance. On the other hand, power receiving coils may be provided on the car 2, but are limited in number (one in this example). Thus, the increase in installation cost and the time and cost of maintenance can be controlled even if the length of the power receiving coil(s) 13 is large.

The intervals of the plurality of power transmitting coils 10 in the moving direction of the car MD should preferably be set smaller than the length of the power receiving coil 13. With such a setting, at least one of the power transmitting coils 10 faces the power receiving coil 13 regardless of the position of the car 2. As a result, electric power can always be transmitted from the power transmitting coils 10 to the power receiving coil 13 regardless of the position of the car 2. This allows the load device 9 to be powered without interruption while the car 2 is moving, further increasing the operating efficiency of the elevator.

The plurality of power transmitting coils 10 may be arranged such that they are equally spaced in line with the moving direction of the car 2. For example, among the plurality of power transmitting coils 10, the power transmitting coil 10 at the lowest position is set to face the power receiving coil 13 when the car 2 stops at the lowest floor, and the power transmitting coil 10 at the highest position is set to face the power receiving coil 13 when the car 2 stops at the highest floor. Between these two power transmitting coils 10, a plurality of the power transmitting coils 10 are arranged at a constant interval smaller than the length of the power receiving coil 13.

Next, the control of the power transmitting unit switches 15 and the power transmitting coil switches 12 by the control panel 5 and the controlling device 7 will be described in detail.

The control panel 5 and the controlling device 7 obtain position information representing the present position of the car 2. The position information is obtained by, for example, a position information detector (not shown). Instead, the controlling device 7 may obtain the position information on the basis of the current information from the detection circuits 8 and provide the position information to the control panel 5 in real time.

The control panel 5 controls the power transmitting unit switches 15 on the basis of the position information so that electric power is supplied from the main power supply 6 to the power transmitting unit 3 including the power transmitting coils 10 facing the power receiving coil 13.

The controlling device 7 controls the power transmitting coil switches 12 on the basis of the position information so that the power transmitting coils 10, among the plurality of power transmitting coils 10 of the power transmitting unit 3 connected to the main power supply 6, facing the power receiving coil 13 are connected to the power transmitting device 11. Also, the controlling device 7 controls the power transmitting device 11 so that electric power is transmitted from the power transmitting coils 10 facing the power receiving coil 13 to the power receiving coil 13.

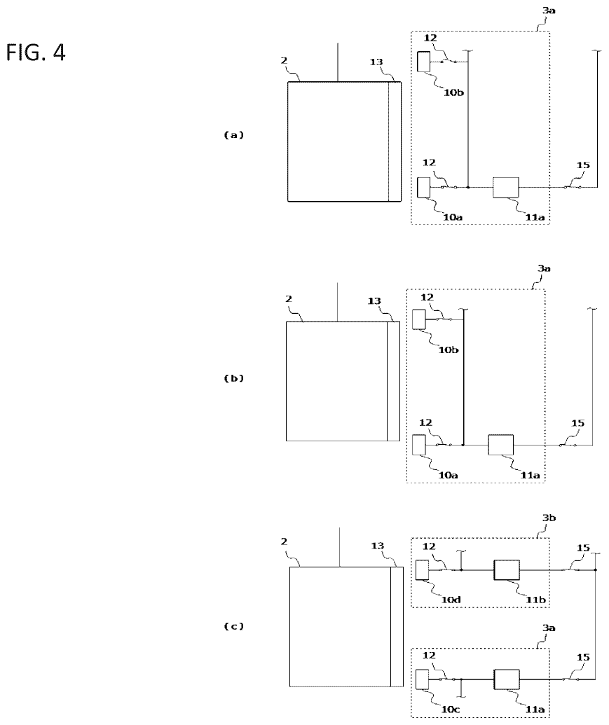

FIG. 4 is a schematic side view showing the change in a positional relationship between the power transmitting coils 10 and the power receiving coil 13. In FIG. 4, to distinguish between the plurality of power transmitting units 3, between the plurality of power transmitting devices 11, and between the plurality of power transmitting coils 10, the two different power transmitting units 3 are referred to as power transmitting units 3a and 3b, the two different power transmitting devices 11 are referred to as power transmitting devices 11a and 11b, and the four different power transmitting coils 10 are referred to as power transmitting coils 10a, 10b, 10c, and 10d, respectively.

The power transmitting units 3a and 3b are placed next to each other vertically. The power transmitting unit 3a includes the power transmitting coils 10a, 10b, 10c and the power transmitting device 11a; and the power transmitting unit 3b includes the power transmitting coil 10d and the power transmitting device 11b. Among the plurality of power transmitting coils 10 included in the power transmitting unit 3a, the power transmitting coils 10a, 10b, and 10c correspond to the one at the lowest position, the one at the second lowest position, and the one at the highest position, respectively. Among the plurality of power transmitting coils 10 included in the power transmitting unit 3b, the power transmitting coil 10d corresponds to the one at the lowest position.

In the example shown in FIG. 4(a), the power receiving coil 13 faces the power transmitting coil 10a. In this case, the control panel 5 controls the corresponding power transmitting unit switch 15 to be in the connected state so that electric power is supplied from the main power supply 6 to the power transmitting unit 3a. Also, the controlling device 7 controls the corresponding power transmitting coil switch 12 to be in the connected state so that the power transmitting coil 10a is connected to the power transmitting device 11a. In this situation, the controlling device 7 controls the power transmitting device 11a so that electric power is transmitted from the power transmitting coil 10a to the power receiving coil 13.

In the example shown in FIG. 4(b), the power receiving coil 13 faces the power transmitting coils 10a and 10b, both of which are included in the same power transmitting unit 3a and are placed next to each other. In this case, the control panel 5 controls the corresponding power transmitting unit switch 15 to be in the connected state so that electric power is supplied from the main power supply 6 to the power transmitting unit 3a. Also, the controlling device 7 controls the corresponding two the power transmitting coil switches 12 to be in the connected state so that the respective power transmitting coils 10a and 10b are connected to the power transmitting device 11a. In this situation, the controlling device 7 controls the power transmitting device 11a so that electric power is transmitted from the power transmitting coils 10a and 10b to the power receiving coil 13.

In the example shown in FIG. 4(c), the power receiving coil 13 faces the power transmitting coils 10c and 10d, which are included in the different power transmitting units 3a and 3b, respectively, and placed next to each other. In this case, the control panel 5 controls the corresponding two power transmitting unit switches 15 to be in the connected state so that electric power is supplied from the main power supply 6 to the power transmitting units 3a and 3b. Also, the controlling device 7 controls the corresponding two the power transmitting coil switches 12 to be in the connected state so that the power transmitting coils 10c and 10d are connected to the power transmitting device 11a and 11b, respectively. In this situation, the controlling device 7 controls the power transmitting devices 11a and 11b so that electric power is transmitted from the power transmitting coils 10c and 10d to the power receiving coil 13.

It should be noted here that the change in the position of the car 2 changes the electric power that can be transmitted from one or more of the power transmitting coils 10 to the power receiving coil 13 (hereinafter referred to as transmittable electric power). For example, while the car 2 is moving, when the number of the power transmitting coils 10 facing the power receiving coil 13 changes, the transmittable electric power changes. If the transmittable electric power changes with the movement of the car 2 to be lower than the electric power required by the load device 9 (hereinafter referred to as required electric power), sufficient electric power cannot be supplied to the load 10) device 9, causing the operation of the load device 9 to become unstable. To cope with this, the control panel 5 or the controlling device 7 may control the load device 9 on the basis of the transmittable electric power to adjust the required electric power of the load device 9.

The transmittable electric power depends on the electrical characteristics of the power transmitting coils 10 to the power receiving coil 13. The electrical characteristics of each power transmitting coil 10 to the power receiving coil 13 are determined, for example, by parameters such as a current flowing in each power transmitting coil 10, an impedance of the load device 9 as viewed from each power transmitting device 11, or a coupling factor between each power transmitting coil 10 and the power receiving coil 13 (hereinafter referred to as power transmission parameters). Therefore, the transmittable electric power can be calculated on the basis of the power transmission parameters for each power transmitting coil 10.

An example of controlling the load device 9 on the basis of the transmittable electric power of each power transmitting coil 10 will be described below.

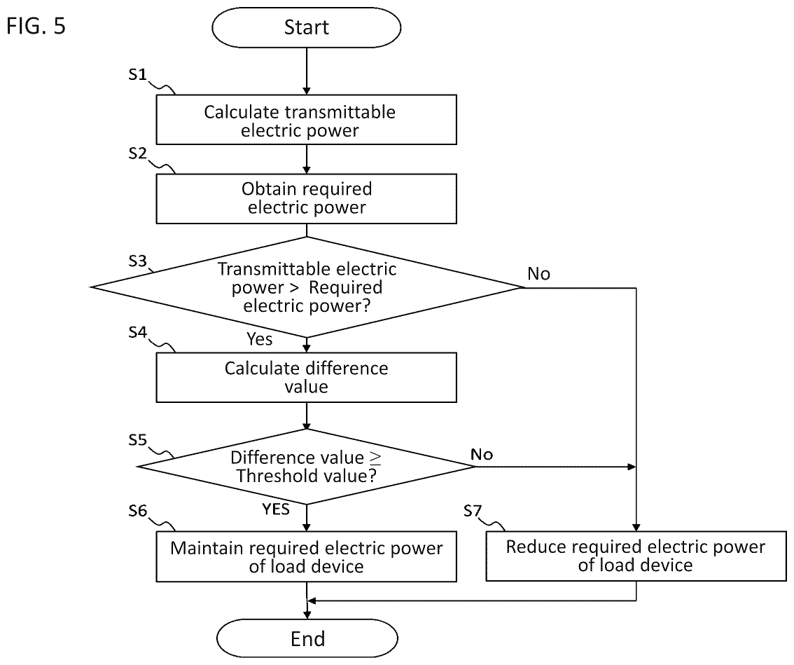

FIG. 5 is a flowchart showing an example of controlling the load device 9 on the basis of the transmittable electric power. In this example, the current information from the detection circuits 8 is used as the power transmission parameter.

In the following description, the control operation of the control panel 5 and the control operation of the controlling device 7 are not distinguished, but are described as the control operation of the controller 50. The following control operation can be performed by the control panel 5 and the controlling device 7 together, or by either of them independently.

The controller 50 repeats the following process in a constant cycle. First, the controller 50 calculates the transmittable electric power at the present time on the basis of the current information from the detection circuits 8 (step S1). In this case, the controller 50 can calculate the transmittable electric power from the power transmission parameter using a predetermined formula or map, etc.

An approximate transmittable electric power can also be obtained from the present position of the car 2. Therefore, the controller 50 may calculate the transmittable electric power on the basis of the position information instead of the power transmission parameter (current information). For example, when a map showing the relationship between the position of the car 2 and the transmittable electric power is prepared in advance, the transmittable electric power is calculated from the position information using the map.

Next, the controller 50 obtains the required electric power of the load device 9 (step S2). For example, the controller 50 detects an electric power consumption of the load device 9 using a detector (not shown). When the load device 9 is operating stably, the electric power consumption at the present time can be considered as the required electric power at the present time. The required electric power may be calculated on the basis of the information about the operation of the load device 9, such as a set temperature of the air conditioner.

Next, the controller 50 determines whether the transmittable electric power calculated in step S1 is larger than the required electric power calculated in step S2 (step S3). When the transmittable electric power is large and less than or equal to the required electric power, the controller 50 performs the process of step S7 described below. When the transmittable electric power is larger than the required electric power, the controller 50 calculates the difference value between the transmittable electric power calculated in step S1 and the required electric power obtained in step S2 (step S4). Next, the controller 50 determines whether the difference value calculated in step S4 is larger than or equal to a predetermined threshold value (step S5).

If the difference value is larger than or equal to the threshold value, the transmittable electric power is sufficient for the required electric power. Therefore, the controller 50 operates the load device 9 as in the present state to maintain the required electric power of the load device 9 (step S6). If the difference value is less than the threshold value, it indicates that the transmittable electric power has come closer to the required electric power. In this case, the controller 50 controls the load device 9 so that the required electric power of the load device 9 is reduced (step S7). For example, if the load device 9 is an air conditioner, the required electric power depends on intensity of air conditioning, a set temperature, etc., of the air conditioner. Thus, the controller 50 changes the intensity of air conditioning or the set temperature of the air conditioner so that the required electric power is reduced. Instead, the required electric power of the air conditioner can be reduced by switching the operating mode of the load device 9 from “cooling” to “blowing” or “stopped”, etc. After the required electric power of the load device 9 is reduced in step S6, when the transmittable electric power becomes sufficiently large again, the operation of the load device 9 can be restored to its original state.

Thus, when the transmittable electric power is sufficiently large relative to the required electric power of the load device 9, the operation of the load device 9 is maintained as is, and when the transmittable electric power approaches the required electric power of the load device 9, the required electric power of the load device 9 is reduced in advance. This prevents the transmittable electric power from falling below the required electric power of the load device 9.

Also, if the transmittable electric power is less than or equal to the required electric power (NO in step S3), the required electric power of the load device 9 is reduced in step S7. As a result, the state in which the transmittable electric power is larger than the required electric power can be restored early.

In the example shown in FIG. 5, the required electric power of the load device 9 is adjusted on the basis of the comparison between the transmittable electric power calculated from the power transmission parameter and the required electric power. However, the transmittable electric power does not necessarily have to be calculated. For example, a threshold value corresponding to the power transmission parameter is determined on the basis of the required electric power, and then the required electric power of the load device 9 can be adjusted on the basis of the comparison between the power transmission parameter obtained in step S1 and the set threshold value. There is a correlation between the transmittable electric power and each power transmission parameter. Therefore, even if the transmittable electric power is not used directly as in the example above, the use of the power transmission parameter allows virtually the same control as when the transmittable electric power is used.

The controller 50 may adjust the required electric power of the load device 9 on the basis of the number of the power transmitting coils 10 facing the power receiving coil 13. For example, if the number of the power transmitting coils 10 facing the power receiving coil 13 changes, the transmittable electric power may change. Therefore, the controller 50 may control the load device 9 such that the required electric power of the load device 9 changes in accordance with the number of the power transmitting coils 10 facing the power receiving coil 13. The number of the power transmitting coils 10 facing the power receiving coil 13 can be determined on the basis of the position information or the power transmission parameters.

For example, the required electric power of the load device 9 is adjusted to different values between the case as in the example of FIG. 4(b) or FIG. 4(c), where the number of the power transmitting coils 10 facing the power receiving coil 13 is two and the case as in the example of FIG. 4(a), where the number of the power transmitting coils 10 facing the power receiving coil 13 is one. This prevents the transmittable electric power from falling below the required electric power of the load device 9 when the number of the power transmitting coils 10 facing the power receiving coil 13 changes.

Also, as in the example of FIG. 4(b) and the example of FIG. 4(c), the transmittable electric power may be different depending on whether the plurality of power transmitting coils 10 facing the power receiving coil 13 are connected to the same power transmitting device 11 or the different power transmitting devices 11. In this case, the controller 50 can change the required electric power of the load device 9 in accordance with whether the plurality of power transmitting coils 10 facing the power receiving coil 13 are connected to the same power transmitting device 11 or the different power transmitting devices 11.

In addition, the controller 50 may control the load device 9 on the basis of both the transmittable electric power and the number of the power transmitting coils 10 facing the power receiving coil 13. For example, in the case where the number of the power transmitting coils 10 facing the power receiving coil 13 is one, when the difference value between the transmittable electric power and the required electric power is less than a threshold value, the required electric power of the load device 9 is adjusted to a first value lower than the present value. In the case where the number of the power transmitting coils 10 facing the power receiving coil 13 is two, when the difference value between the transmittable electric power and the required electric power is less than the threshold value, the required electric power of the load device 9 is adjusted to a second value different from the first value.

Similarly, while adjusting the required electric power in accordance with whether the plurality of power transmitting coils 10 facing the power receiving coil 13 are connected to the same power transmitting device 11 or the different power transmitting devices 11, the controller 50 may further adjust the required electric power on the basis of the comparison between the transmittable electric power and the required electric power.

The required electric power of the load device 9 may be adjusted in accordance with the change in position of the power receiving coil 13 with respect to each power transmitting coil 10.

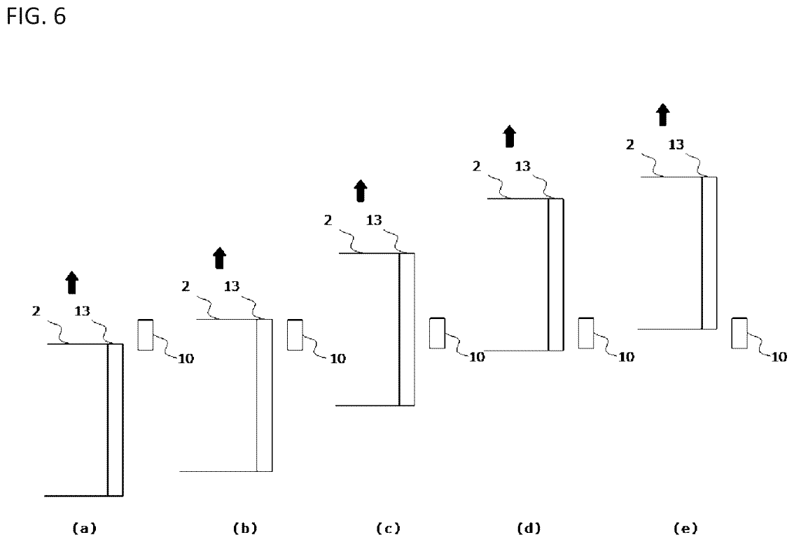

FIG. 6 is a schematic side view showing the change in position of the power receiving coil 13 with respect to one specific power transmitting coil 10. The car 2 moves up in the order of FIG. 6(a), FIG. 6(b), FIG. 6(c), FIG. 6(d), and FIG. 6(e). Thus, the position of the power receiving coil 13 is gradually elevated with respect to the specific power transmitting coil 10.

In the example shown in FIG. 6(a), the power receiving coil 13 faces only the lower end portion of the power transmitting coil 10. In the example shown in FIG. 6(e), the power receiving coil 13 faces only the upper end portion of the power transmitting coil 10. In a state in which the power receiving coil 13 faces only a part of the power transmitting coil 10 as in these examples (hereinafter, referred to as a first facing state), the coupling factor between the power receiving coil 13 and the power transmitting coil 10 is low, and the transmittable electric power is small.

In the examples shown in FIG. 6(b) and FIG. 6(d), the power receiving coil 13 faces the entire power transmitting coil 10. In addition, in the example shown in FIG. 6(b), the upper end of the power receiving coil 13 is at the same level as the upper end of the power transmitting coil 10, and in the example shown in FIG. 6(d), the lower end of the power receiving coil 13 is at the same level as the lower end of the power transmitting coil 10. In the state in which the power receiving coil 13 faces the entire power transmitting coil 10 and one end of the power receiving coil 13 is close to one end of the power transmitting coil 10, as shown in the above examples (hereinafter referred to as a second facing state), the coupling factor between the power receiving coil 13 and the power transmitting coil 10 is high, and the transmittable electric power is large.

In the example shown in FIG. 6(c), the power receiving coil 13 faces the entire power transmitting coil 10. However, the upper end of the power receiving coil 13 is at a higher level than the upper end of the power transmitting coil 10, and the lower end of the power receiving coil 13 is at a lower level than the lower end of the power transmitting coil 10. In the state in which the power receiving coil 13 faces the entire power transmitting coil 10 and the ends of the power receiving coil 13 are away from the ends of the power transmitting coil 10, as shown in the above example (hereinafter referred to as a third facing state), both the coupling factor between the power receiving coil 13 and the power transmitting coil 10 and the transmittable electric power are between those of the first facing state and the second facing state. That is, the coupling factor in the third facing state is higher than that in the first facing state and lower than that in the second facing state. Also, the transmittable electric power in the third state is larger than that in the first facing state and less than that in the second facing state.

Therefore, the controller 50 may determine which of the first, second, and third facing states is the current facing state on the basis of the position information or the power transmission parameters, and adjust the required electric power of the load device 9 on the basis of the determination result. Specifically, the load device 9 is controlled such that the required electric power of the load device 9 is the largest in the second facing state, the second largest in the third facing state, and the smallest in the first facing state. For example, the intensity of air conditioning may be adjusted to be the highest in the second facing state, the second highest in the third facing state, and the lowest in the first facing state.

Also, while the car 2 is moving, when the power transmitting coils 10 to transmit electric power to the power receiving coil 10 are switched, the transmittable electric power may decrease instantaneously. Therefore, while the car 2 is moving, the required electric power of the load device 9 may be adjusted lower in advance before the power transmitting coils 10 to transmit electric power to the power receiving coil 10 are switched on the basis of the position information or the power transmission parameters. For example, since the time until the power transmitting coils 10 are switched is predicted on the basis of the position information, the load device 9 is controlled such that the required electric power of the load device 9 becomes lower when the predicted time is less than or equal to a threshold value. This prevents the operation of the load device 9 from becoming unstable when the power transmitting coils 10 are switched.

Also, the load device 9 can be supplied with electric power without interruption through the power receiving coil 13 by setting the length of the power receiving coil 13 to be large and arranging the plurality of power transmitting coils 10 such that at least one power transmitting coil 10 faces the power receiving coil 13 as described above. In this case, by adjusting the required electric power of the load device 9 on the basis of the transmittable electric power, etc., the load device 9 can be operated continuously and stably. As a result, the service quality for passengers on the car 2 can be maintained at a high level.

### Embodiment 2

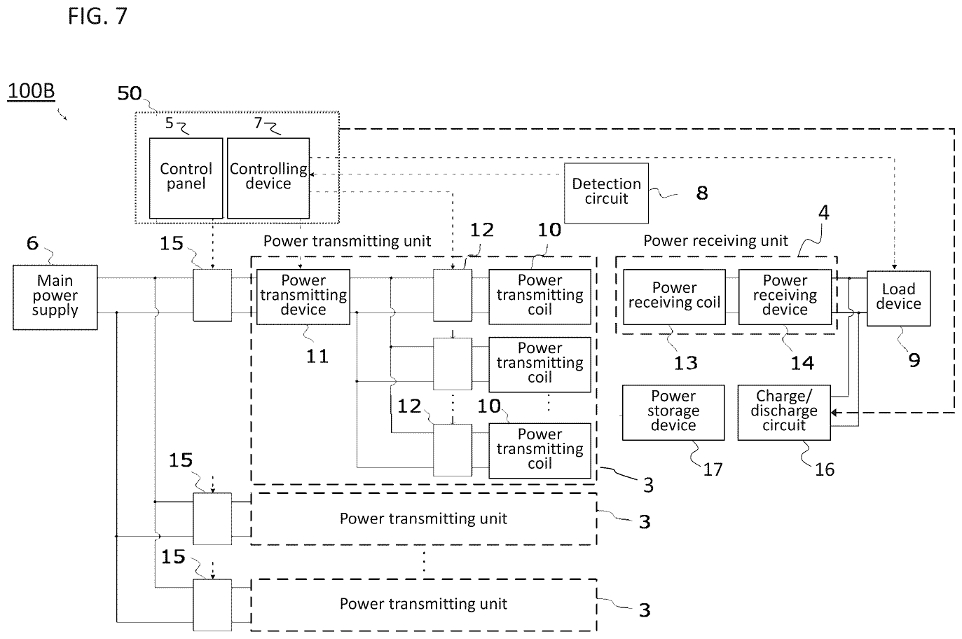

A wireless power transfer system according to Embodiment 2 of the present disclosure will be described, focusing on the differences from Embodiment 1 above. FIG. 7 is a block diagram showing a configuration of a wireless power transfer system 100B according to Embodiment 2.

The wireless power transfer system 100B according to Embodiment 2 includes a charge/discharge circuit 16 and a power storage device 17 in addition to the configuration of the wireless power transfer system 100A. The charge/discharge circuit 16 and the power storage device 17 are installed in the car 2. The power storage device 17 is, for example, a lithium-ion battery configured to be capable of charging and discharging. Not limited to the lithium-ion battery, the power storage device 17 may be a lead-acid battery or an electrolytic capacitor, etc., as long as it is capable of charging and discharging.

The power storage device 17 is connected to an output terminal of the power receiving device 14 and an input terminal of the load device 9 through the charge/discharge circuit 16. The charge/discharge circuit 16 charges the power storage device 17 by supplying the electric power outputted from the power receiving device 14 to the power storage device 17. Also, the charge/discharge circuit 16 supplies electric power from the power storage device 17 to the load device 19 by causing the power storage device 17 to discharge.

When the transmittable electric power is larger than the required electric power of the load device 9, the controller 50 (the control panel 5 or the controlling device 7) controls the charge/discharge circuit 16 such that a part of the electric power transmitted from the power transmitting coils 10 to the power receiving coil 13 is supplied to the power storage device 17. When the transmittable electric power is less than the required electric power of the load device 9, the controller 50 controls the charge/discharge circuit 16 such that electric power is supplied from the power storage device 17 to the load device 9. Thus, when the transmittable electric power is large enough, the excess electric power is stored in the power storage device 17, and when the transmittable electric power is insufficient, the shortage is made up by the electric power stored in the power storage device 17. Thus, even if the transmittable electric power changes with the movement of the car 2, the load device 9 can be operated continuously without causing the electric power consumption of the load device 9 to change significantly. This allows the load device 9 to operate more stably.

In addition, even in the case where the interval between the plurality of power transmitting coils 10 is larger than the length of the power receiving coil 13, that is, in the case where there is a period of time when the power receiving coil 13 does not face any of the power transmitting coils 10, the load device 9 can still be stably operated by the electric power supplied from the power storage device 17 to the load device 9. As a result, the number of the power transmitting coils 10 can be reduced while suppressing the decrease of the operating efficiency of the elevator, which leads to controlling the increase of the installation cost and the time and cost of maintenance.

However, if the power storage device 17 does not have a sufficient amount of charged power, the load device 9 may not be able to be supplied with sufficient electric power. To cope with this, the controller 50 may constantly monitor (detect) the charge amount of the power storage device 17 and adjust the required electric power of the load device 9 on the basis of the charge amount of the power storage device 17.

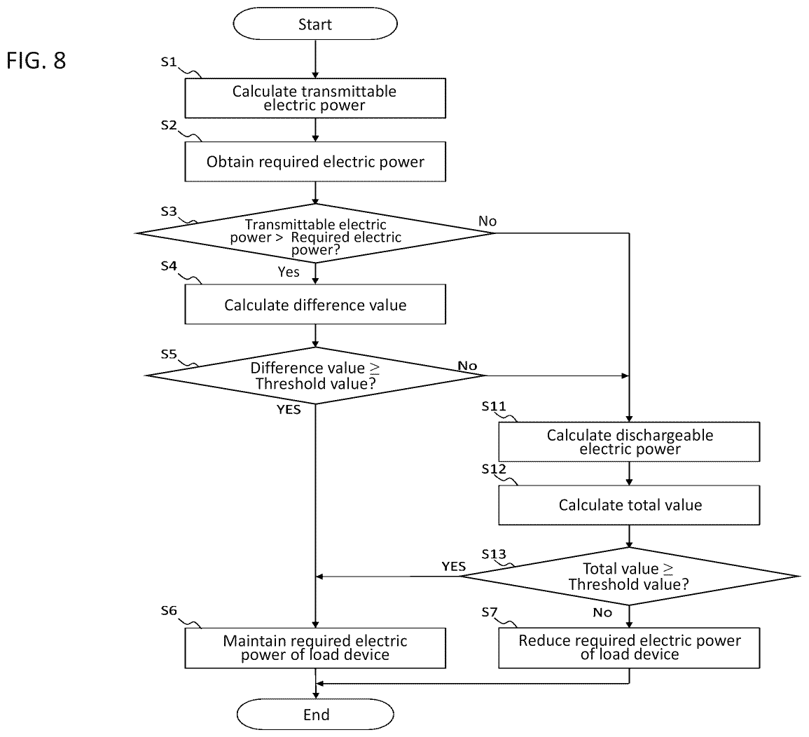

FIG. 8 is a flowchart showing an example of controlling the load device 9 on the basis of the charge amount of the power storage device 17. The control example in FIG. 8 will be described, focusing on the differences from the control example in FIG. 5.

In the example shown in FIG. 8, in step S3, if the transmittable electric power is less than or equal to the required electric power, or in step S5, if the difference value between the transmittable electric power and the required electric power is less than a threshold value, the controller 50 calculates the electric power transmittable from the power storage device 17 to the load device 9 (hereinafter referred to as dischargeable electric power) on the basis of the charge amount of the power storage device 17 (step S11).

Next, the controller 50 calculates the total value of the transmittable electric power calculated in step S1 and the dischargeable electric power calculated in step S11 (step S12). Next, the controller 50 determines whether the calculated total value is equal to or larger than the above threshold value (step S13). The threshold values in step S5 and step S13 may be set to different values.

If the total value is larger than or equal to the threshold value, the shortage of the transmittable electric power can be fully made up by the discharged electric power from the power storage device 17. Therefore, if the total value is larger than or equal to the threshold value, the controller 50 maintains the operation of the load device 9 as is such that the required electric power of the load device 9 is maintained (step S5). On the other hand, if the total value is smaller than the threshold value, the shortage of the transmittable electric power may not be able to be made up by the discharged electric power from the power storage device 17. Therefore, if the total value is smaller than the threshold value, the controller 50 controls the load device 9 such that the required electric power of the load device 9 is reduced (step S6).

In this way, the adjustment of the required electric power of the load device 9 on the basis of the transmittable electric power and the charge amount of the power storage device 17 prevents the electric power supplied to the load device 9 from falling below the required electric power of the load device 9 by reducing the required electric power of the load device 9 even when the charge amount of the power storage device 17 is insufficient to make up for the shortage of the transmittable electric power. This prevents the operation of the load device 9 from becoming unstable.

If there is a period of time when the power receiving coil 13 does not face any of the power transmitting coils 10, it is necessary to supply electric power from the power storage device 17 to the load device 9 without interruption during this period. The electric power required for this period depends on the number of passengers on the car 2, the destination floors, the operating time of day, etc. Therefore, the required electric power of the load device 9 may be adjusted on the basis of the number of passengers on the car 2, the destination floors, the operating time of day, etc.

### Embodiment 3

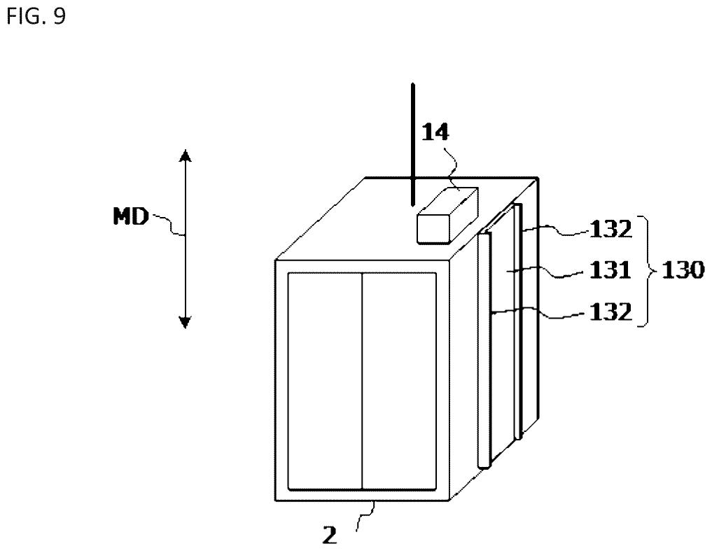

A wireless power transfer system according to Embodiment 3 of the present disclosure will be described, focusing on the differences from Embodiment 1 above. The wireless power transfer system according to Embodiment 3 includes a power receiving coil 130 shown below instead of the power receiving coil 13 of FIG. 1. FIG. 9 is a schematic perspective view showing the power receiving coil 130 installed on the car 2.

The power receiving coil 130 in FIG. 9 has a flat portion 131 and a pair of protruding portions 132. The flat portion 131 has the same configuration as the power receiving coil 13 of FIG. 1 and is provided to extend in the moving direction of the car MD and to have an elongated shape. The pair of protruding portions 132 are provided so as to protrude by a certain width toward the power transmitting coils 10 from a pair of sides of the flat portion 131 along the moving direction of the car MD.

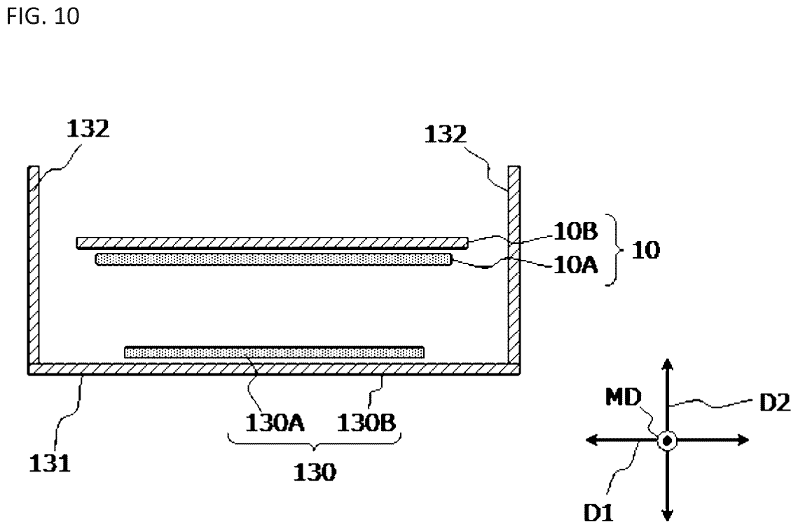

FIG. 10 is a schematic cross-sectional view showing the power receiving coil 130 of FIG. 9 and the power transmitting coil 10 facing the power receiving coil 130. The cross-sectional area of FIG. 10 is perpendicular to the moving direction of the car MD. As shown in FIG. 10, the power receiving coil 130 includes a winding 130A and a magnetic material 130B. The flat portion 131 has a two-layer structure with the winding 130A and the magnetic material 130B. On the other hand, each of the protruding portions 132 is made of the magnetic material 130B.

In a situation where the power receiving coil 130 and the power transmitting coil 10 face each other, the power transmitting coil 10 is positioned between the pair of protruding portions 132. That is, in a first direction D1 perpendicular to the moving direction of the car MD, the width of the flat portion 131 is larger than the width of the power transmitting coil 10. Then, the first direction D1 is parallel to the surface of the flat portion 131 facing the power transmitting coil 10 and the surface of the power transmitting coil 10 facing the power receiving coil 130. In a second direction D2 perpendicular to both the moving direction of the car MD and the first direction D1, the widths of the protruding portions 132 are larger than the distance between the flat portion 131 and the power transmitting coil 10. Therefore, while the car 2 is moving, the power transmitting coils 10 move between the pair of protruding portions 132 while remaining facing the flat portion 131.

Since the power receiving coil 130 of the present embodiment has the protruding portions 132 protruding from the flat portion 131 toward the power transmitting coils 10, the flux density between the power transmitting coils 10 and the power receiving coil 130 is increased compared to when the power receiving coil 13 of FIG. 1 is used, resulting in a larger coupling factor therebetween. This increases the transmittable electric power from the power transmitting coils 10 to the power receiving coil 130 as compared to Embodiment 1. As a result, the load device 9 can be supplied with stable electric power and the load device 9 can be operated in a stable manner. It also allows the load device 9 to be operated at the electric power consumption of the wider range, thereby improving the quality of service for the passengers of the car 2.

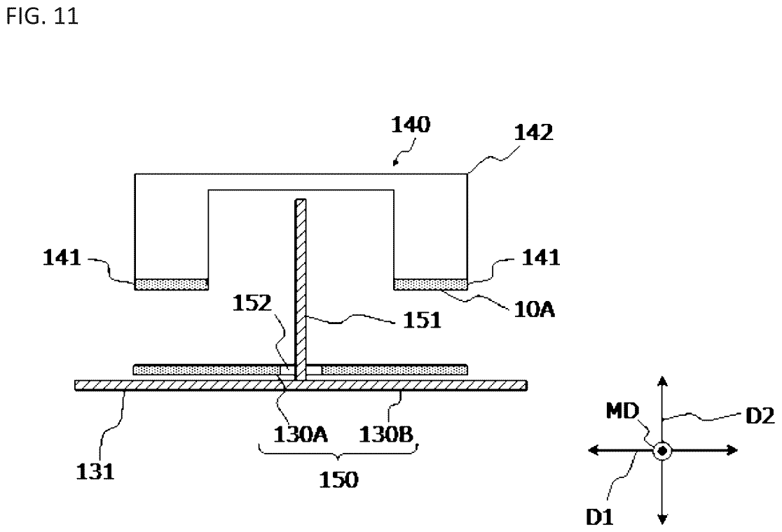

FIG. 11 is a schematic cross-sectional view showing another modification of the power transmitting coils 10 and the power receiving coil 13. Instead of the power transmitting coils 10 and the power receiving coil 13 of FIG. 1, power transmitting coils 140 and a power receiving coil 150 of FIG. 11 may be used. One of the power transmitting coils 140 and the power receiving coil 150 shown in FIG. 11 will be described, focusing on the differences from the power transmitting coil 10 and the power receiving coil 130 of FIG. 10.

The power transmitting coil 140 of FIG. 11 has the winding 10A and does not have the magnetic material 10B. The power transmitting coil 140 has a pair of proximity portions 141 and a pair of connection portions 142. In FIG. 11, only one of the pair of connection portions 142 is shown. The pair of proximity portions 141 are separated from each other in the first direction and connected to each other via the pair of connection portions 142. In the second direction D2, the pair of connection portions 142 are more distant from the car 2 than the pair of proximity portions 141.

The power receiving coil 150 has one protruding portion 151 instead of the pair of protruding portions 132. The protruding portion 151 is provided to protrude from the center of the flat portion 131 in the first direction D1 toward the power transmitting coil 140. The protruding portion 151, made of the magnetic material 130B, protrudes toward the power transmitting coil 140 through a hole 152 provided in the winding 130A.

The distance between the proximity portions 141 and the flat portion 131 in the second direction D2 is smaller than the width of the protruding portion 151 in the second direction D2. While the car 2 is moving, the protruding portion 151 of the power receiving coil 150 passes between the pair of proximity portions 141 of the power transmitting coils 140, and in the second direction D2, each of the proximity portions 141 faces the winding 130A of the power receiving coil 150.

Similarly, when the power transmitting coils 140 and the power receiving coil 150 of FIG. 11 are used, the flux density between the power transmitting coils 140 and the power receiving coil 150 is increased compared to when the power transmitting coils 10 and the power receiving coil 13 of FIG. 1 are used, resulting in a larger coupling factor therebetween. This increases the transmittable electric power from the power transmitting coils 140 to the power receiving coil 150 as compared to Embodiment 1. As a result, the load device 9 can be supplied with stable electric power and the load device 9 can be operated in a stable manner. It also allows the load device 9 to be operated at the electric power consumption of the wider range, thereby improving the quality of service for the passengers of the car 2.

The power receiving coil 130, or the power transmitting coils 140 and the power receiving coil 150 in the present embodiment, may be used for the wireless power transfer system according to Embodiment 2. When the power receiving coil 130 or the power transmitting coils 140 and the power receiving coil 150 in the present embodiment are used, the transmittable electric power increases, so that a surplus of electric power is likely to occur. Therefore, the power storage device 17 will be able to accumulate sufficient electric power. Thus, even when the transmittable electric power falls below the required electric power of the load device 9, the power storage device 17 supplies the electric power to the load device 9, thereby enabling the load device 9 to operate stably.

### OTHER EMBODIMENTS

In the above embodiments, only one power receiver (power receiving coil 10, 130, 150) is installed on the car 2. However, the invention is not limited thereto, and a plurality of power receivers may be installed on the car 2. The plurality of power receivers may be arranged vertically or horizontally. The plurality of power receivers may be located on different sides of the car 2.

When the plurality of power receivers are arranged horizontally or on the different sides of the car 2, the plurality of power transmitters (power transmitting coils 10, 140) are arranged to form a plurality of arrays corresponding to the plurality of power receivers.

In the above embodiments, the power transmitting unit 3 includes the plurality of power transmitters for one power transmitting device 11. However, the configuration of the power transmitting unit 3 is not limited thereto, and only one power transmitter may be provided for one power transmitting device 11.

In the above embodiments, the current flowing in each power transmitting coil 10 is used as the power transmission parameter for each power transmitter. However, other parameters, such as the impedance of the load device 9 as viewed from each power transmitting device 11 or the coupling factor between each power transmitter and the power receiver, may be used as the power transmission parameter. In this case, the detector for detecting the parameter used may be provided separately, and the transmittable electric power may be calculated on the basis of the detection result by the detector.

The embodiments disclosed herein may also be combined as appropriate within the scope of compatibility. The embodiment disclosed herein should be considered illustrative and not restrictive in all respects. The technical scope of the present disclosure is defined by the claims, not by the description set forth above, and is intended to include all modifications equivalent in meaning and within the scope of the claims.

### DESCRIPTION OF THE SYMBOLS

1 . . . hoistway
2 . . . car
3 . . . power transmitting unit
4 . . . power receiving unit
5 . . . control panel
6 . . . main power supply
7 . . . controlling device
8 . . . detection circuit
9 . . . load device
10, 140 . . . power transmitting coil
11 . . . power transmitting device
12 . . . power transmitting coil switch
13, 130, 150 . . . power receiving coil
14 . . . power receiving device
15 . . . power transmitting unit switch
16 . . . charge/discharge circuit
17 . . . power storage device
19 . . . load device
50 . . . controller
100 . . . elevator system
100A, 100B . . . wireless power transfer system

1. A wireless power transfer system to supply electric power without contact to a car moving in a hoistway of an elevator, the wireless power transfer system comprising:
a plurality of power transmitters disposed in the hoistway so as to be aligned over multiple floors in a moving direction of the car;
a power transmitting device to supply electric power to the plurality of power transmitters;
a power receiver to receive electric power from the plurality of power transmitters without contact, the power receiver being installed on the car;
a power receiving device to receive electric power from the power receiver;
a load device to which the electric power received by the power receiving device is supplied; and
a controller to control the power transmitting device and the power receiving device,
wherein a dimension of the power receiver in the moving direction of the car is larger than a dimension of each of the plurality of power transmitters in the moving direction of the car,
wherein intervals of the plurality of power transmitters in the moving direction of the car are smaller than the dimension of the power receiver in the moving direction of the car and larger than the dimension of each of the plurality of power transmitters in the moving direction of the car.

2. (canceled)

3. The wireless power transfer system according to claim 1, wherein the plurality of power transmitters are arranged to be equally spaced in line with the moving direction of the car.

4. The wireless power transfer system according to claim 1, wherein the controller controls the operation of the load device such that the transmittable electric power from at least one of the power transmitters facing the power receiver to the power receiver does not fall below required electric power of the load device, the required electric power being electric power required for stable operation of the load device.

5. The wireless power transfer system according to claim 4, wherein the controller calculates the transmittable electric power on the basis of parameters representing electrical characteristics of the power transmitters facing the power receiver.

6. The wireless power transfer system according to claim 4, wherein the controller adjusts the required electric power of the load device on the basis of position information representing a present position of the car.

7. The wireless power transfer system according to claim 4, wherein when a difference between the transmittable electric power and the required electric power is less than a threshold value, the controller adjusts the required electric power of the load device to reduce the required electric power of the load device.

8. The wireless power transfer system according to claim 4, wherein the controller adjusts the required electric power of the load device on the basis of the number of the power transmitters facing the power receiver.

9. The wireless power transfer system according to claim 4, further comprising:
a power storage device; and
a charge/discharge circuit to charge the power storage device by supplying the electric power received by the power receiving device to the power storage device, and to supply the electric power from the power storage device to the load device by discharging the power storage device,
wherein the controller controls the charging and the discharging by the charge/discharge circuit on the basis of the transmittable electric power.

10. The wireless power transfer system according to claim 9, wherein the controller controls the charge/discharge circuit such that the power storage device is charged when the transmittable electric power is larger than the required electric power of the load device, and the power storage device is discharged when the transmittable electric power is less than the required electric power of the load device.

11. The wireless power transfer system according to claim 1, wherein the power receiver comprises a flat portion provided to face the power transmitters and a protruding portion protruding from the flat portion toward the power transmitters.

12. The wireless power transfer system according to claim 1, wherein the controller controls operation of the load device such that, when one of the plurality of power transmitters faces the power receiver, electric power consumption of the load device is different in accordance with a relative position of the one power transmitter with respect to the power receiver.
